(19) United States
(12) Patent Application Publication
(10) Pub. No.: US 2010/0030846 A1
(43) Pub. Date: Feb. 4, 2010

(54) METHOD OF SYNCHRONIZATION BETWEEN A MOBILE EQUIPMENT UNIT AND A SMART CARD

(75) Inventors: Christophe Martin, Ceyreste (FR); Laurent Jutard, Allauch (FR); Stéphane Chretien, Le Beausset (FR)

Correspondence Address: BUCHANAN, INGERSOLL & ROONEY PC, POST OFFICE BOX 1404, ALEXANDRIA, VA, 22313-1404, US

(73) Assignee: Gemalto SA, Gemenos (FR)

(21) Appl. No.: 12/375,070

(22) PCT Filed: Jul. 20, 2007
(86) PCT No.: PCT/EP07/57517

§ 371 Date: Jul. 17, 2009

(30) Foreign Application Priority Data
Jul. 28, 2006 (EP) 06291232.4

(51) Int. Cl. G06F 15/16; H04B 1/38

(52) U.S. Cl. 709/203; 455/558

(57) ABSTRACT

The invention relates to a method for synchronizing personal data between a memory of at least one mobile equipment unit and an external device. Each of the mobile equipment units includes or is connected to a SyncML synchronization client. The external device can include a SyncML synchronization server associated with the SyncML synchronization client. In one embodiment the external device is a smart card. The smart card is associated with the mobile equipment unit and the SyncML synchronization client transmits a synchronization request to the SyncML synchronization server. The SyncML synchronization server synchronizes the personal data between the smart card and the mobile equipment unit.

The invention relates to a method for synchronizing personal data between a memory of at least one mobile equipment unit and an external device, each of said at least one mobile equipment units including or being connected to a SyncML synchronization client, said external device comprising a SyncML synchronization server associated with said SyncML synchronization client.

The invention also relates to a smart card.

The invention also relates to an assembly comprising a mobile equipment unit and a smart card, said mobile equipment unit including or being connected to a SyncML synchronization client, said smart card being associated with said mobile equipment unit.

The SyncML protocol is a standard allowing the synchronization of personal data of any type and more particularly contacts and agendas. This standard is more particularly described in the publication “SyncML Specification” accessible on the site of the Open Mobile Alliance, http://www.openmobilealliance.org/tech/affiliates/syncml/syncmlindex.html.

In the meaning of the present application, a SyncML synchronization client is a client transmitting requests to a server conformably to the protocol defined by the SyncML standard and a SyncML synchronization server is a server answering the requests from a client conformably with the protocol defined by the SyncML standard.

Such methods are known for synchronizing data in a mobile equipment unit including a SyncML synchronization client with a SyncML synchronization server located in a fixed terminal for example of the PC type, PC being the English acronym for “Personal Computer”.

When such a SyncML synchronization server is located in the fixed terminal, a synchronization of data can be performed between the mobile equipment unit and the fixed terminal so as to guarantee that the data of the mobile equipment are really the same as those in the fixed terminal. It should be noted that this synchronization is particularly significant when the data are personal contact data in which frequent modifications can be made.

However, such methods have the drawback of requiring the utilization of a fixed terminal which is often temporarily dedicated to this utilization and thus has a connected, expensive, heavy infrastructure which is not compatible with the present needs for mobility. The external devices including the SyncML synchronization server is thus too heavy for the management of the mobile equipment unit data to be efficient.

The invention aims more particularly at remedying such drawbacks.

In addition, in an architecture including a mobile equipment unit and a smart card, for example a mobile telephone including a UICC (which is the English acronym for Universal Integrated Circuit Card) card provided with a SIM (which is the English acronym for Subscriber Identity Module) or a USIM (which is the English acronym for Universal Subscriber Identity Module) or even a RUIM (which is the English acronym for Removable User Identity Module) application, the personal data included in the telephone memory are not synchronized with the card data. Then, with the existing equipment units, if a user looses his or her telephone without loosing his or her SIM card or if the telephone is damaged without the SIM card being damaged, it is impossible to recover the contacts included in the memory of the lost or damaged telephone when the SIM card is inserted into a new telephone. The transferability of the personal data is not guaranteed with the present methods and equipment units.

The invention also aims at remedying such drawbacks.

It has also been provided to install into the above mentioned UICC cards applications making it possible to perform synchronization functionalities. However, such applications require a modification in the mobile equipment unit to adapt or install, on the mobile side, a synchronization application associated with the card synchronization application and this upon each change of mobile telephone when the mobile telephone did not manage synchronization operations beforehand.

The invention also aims at remedying such drawbacks.

A first object of the invention is thus to improve the existing synchronization method relating to the data in a mobile equipment unit.

Another object of the invention is to provide the transferability of the data connected to a mobile equipment unit even though this mobile equipment unit is lost or damaged.

Another object of the invention is to provide such transferability without using heavy or expensive infrastructures.

Another object of the invention is to advantageously use the functionalities of the existing synchronization client in a mobile equipment unit.

At least one of the object according to the invention is reached as it relates to the synchronization of personal data between a memory of at least one mobile equipment unit and one external device, each of said at least one mobile equipment units comprising or being connected to a SyncML synchronization client, said external device comprising a SyncML synchronization server associated with said SyncML synchronization client, characterized in that said external device is a smart card and in that said method includes steps in which,
said smart card is associated with said mobile equipment unit;
said SyncML synchronization client transmits a request for synchronization to said SyncML synchronization server;
said SyncML synchronization server synchronizes said personal data between said smart card and said mobile equipment unit.

According to the invention, the mobile equipment unit is for example a mobile telephone and the smart card is for example an MMC (Multi-Media Card) or a SD (Secure Digital) or a USB (Universal Serial Bus) or a UICC (Universal Integrated Circuits Card) smart card provided with one SIM (Subscriber Identity Module) application when the terminal hosting the card is a mobile connected to a network of the GSM/GPRS (Global System for Mobile communications/General Packet Radio Service) type or a USIM (Universal Subscriber Identity Module), RUIM (Removable User Identity Module) or ISIM (IP Subscriber Identity Module) or EAP-SIM (Extensible Authentication Protocol) application, when the terminal hosting the card is a mobile functioning in a Code Distribution Multiple Access CDMA of the third generation (3GPP) of the UMTS or UTRAN types or the third generation (3GPP2) of the CDMA 2000 type.

According to the invention, the smart card is associated with said mobile equipment unit when an electric connection is provided between the card and the reader for example when the card is positioned in the card reader itself or without any electric connection such as for contactless or hybrid contact/contactless smart cards.

Personal data can then be synchronized between the UICC card and the telephone. Even though the telephone is lost or damaged, the personal data are thus stored in the card as they were when they were in the telephone. The perenniality of the personal data is thus provided by the invention without having to use a heavy infrastructure.

As a SyncML synchronization client is present in the known mobile equipment unit, the invention does not have to develop a new synchronization client within the mobile equipment unit.

In addition, because of the reduced size and the reduced communication and calculation capacities in a smart card, the person skilled in the art will admit it is difficult to carry out a synchronization using the SyncML protocol from a server contained in a smart card. The present invention overcomes these difficulties.

On the contrary, as mentioned hereabove, the person skilled in the art was aiming at other synchronization solutions which do not use SyncML. Specific programs were inserted into the card which required a modification in the mobile equipment unit. The present invention makes it possible to overcome this prejudice.

In order to make the insertion of the SyncML synchronization server into the smart card possible, embodiments of the invention thus relate to the way the SyncML protocol is implemented in the card.

First, the SyncML protocol mentions two application protocols, WBXML or XML. Now, the utilization of XML as an application protocol requires a lot of calculation power which is incompatible with the implementation of the SyncML synchronization server in a smart card according to the invention. Then, according to one embodiment of the invention, said SyncML synchronization server includes a WBXML application protocol.

On the other hand, in order to efficiently manage the modifications on personal data of the SyncML synchronization server according to one embodiment of the invention, said smart card includes a non volatile memory in which is stored a database including server personal data and an event manager comprising actions on said personal data, said step in which said SyncML synchronization synchronizes said personal data between said smart card and said mobile equipment unit includes sub-steps in which:
one personal datum to be updated is updated by an updating action;
said updating action is recorded in said event manager;

and said method includes step in which for any synchronization subsequent to said recording, said personal data is updated by said action.

Thus, when managing a list of actions for all the clients which the server is subsequently connected to at the level of an event manager, it is possible to spare space in memory. This is indeed less expensive in memory than managing a matrix containing for each client specific actions to be performed.

Still in the particular embodiment of the invention, said smart card is connected to a first mobile equipment unit comprising a first SyncML synchronization client;
said first SyncML synchronization client transmits a request for synchronization to said SyncML synchronization server;
said SyncML synchronization server synchronizes said personal data between said smart card and said first mobile equipment unit, said last step comprising sub-steps in which:
a personal data to be updated is updated by an action;
said action is recorded in said event manager;
said smart card is connected to a second mobile equipment unit comprising a second SyncML synchronization client;
said second SyncML synchronization client transmits a request of synchronization to said SyncML synchronization server;
said SyncML synchronization server transmits to said second SyncML synchronization client said action for updating said personal datum to be updated at the level of said second equipment unit.

In order to manage the connection to a plurality of mobile equipment units in the above mentioned method, each of said at least one mobile equipment units is associated with an anchor and said step in which said SyncML synchronization server synchronizes said personal data between said smart card and said mobile equipment unit includes sub-steps in which:
said anchor is recorded in a non volatile memory of said smart card.

In the SyncML protocol, LUIDs meaning Locally Unique Identifiers correspond to numbers assigned by the SyncML synchronization client to a personal datum of a local database at the level of the mobile equipment unit. On the server side, GUIDs for Globally Unique Identifiers are identifiers assigned by the server to a datum used in a database of the server. These two identifiers are used for performing synchronizations between the client data and the server data. In a way known per se, the server creates a correspondence table to know the connection between the LUIDs and the GUIDs.

According to one embodiment of the invention, said method includes steps in which:
said server stores in a non volatile memory of said smart card, a first matrix comprising the GUID identifier of each one of said personal data;
said server stores in a non volatile memory of said smart card, a first matrix comprising, for each one of the GUID identifiers of each one of said personal data, a list of the LUID identifiers of each one of said at least one SyncML synchronization clients.

In addition, the flow of SyncML data exchanged between the client and the server may be significant as regards the communication channel as well as the size of the memory of the smart card according to the invention. More particularly, the size of volatile memories in the present cards does not make it possible to store a packet of SyncML data in a volatile memory prior to their being processed. To remedy such drawback, in the above mentioned method, said step in which said SyncML synchronization server synchronizes said personal data includes sub-steps in which:
said server receives a first packet of synchronization data;
said server stores said first packet in the first memory area of a non volatile memory of said smart card;
said server receives a second packet of synchronization data;
said server stores said second packet in a second memory area of a non volatile memory of said smart card.

Thus, the packets of data can be used by the SyncML synchronization server without using the volatile memory of such smart card.

In order to perform a bilateral synchronization between the SyncML synchronization server and the mobile equipment unit, said smart card includes a non volatile memory in which is stored a server database including server personal data and an event manager comprising actions on said personal data, said step in which said SyncML synchronization server synchronizes said personal data between said smart card and said mobile equipment unit includes sub-steps in which:
said client sends to said server said updated versions relating to personal data stored in said server database;
said server transmits said updated versions to said database;
said database updates said server personal data using said updated versions;
said server searches for actions to be implemented at the level of the mobile equipment unit in said event manager;
said server transmits said actions to said client.

The invention also relates to a smart card comprising at least a memory block and a microprocessor, characterized in that said memory block stores a computer program, said program being so arranged as to perform the functions of a SyncML server when it is run using said microprocessor.

The invention also relates to an assembly comprising a mobile equipment unit and a smart card, said mobile equipment unit comprising or being connected to a SyncML synchronization client, said smart card being associated with said mobile equipment and including at least a memory block and a microprocessor, characterized in that said memory stores a computer program, said program being so arranged as to perform the functions of a SyncML server when it is run using said microprocessor.

Now an embodiment of the invention will be described while referring to the figures appended herein in which:

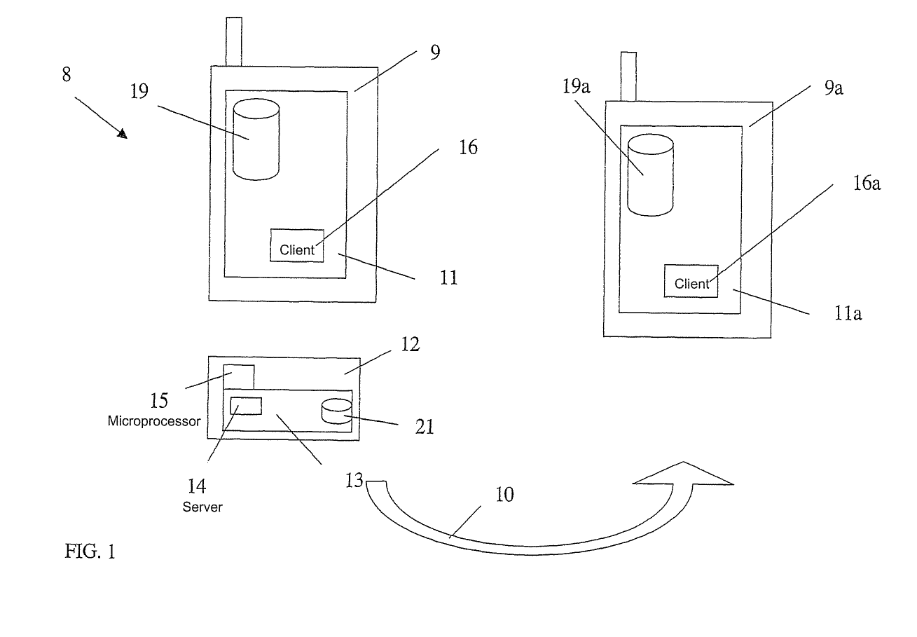

FIG. 1 shows an assembly comprising a mobile equipment unit and a smart card according to a first embodiment of the invention;

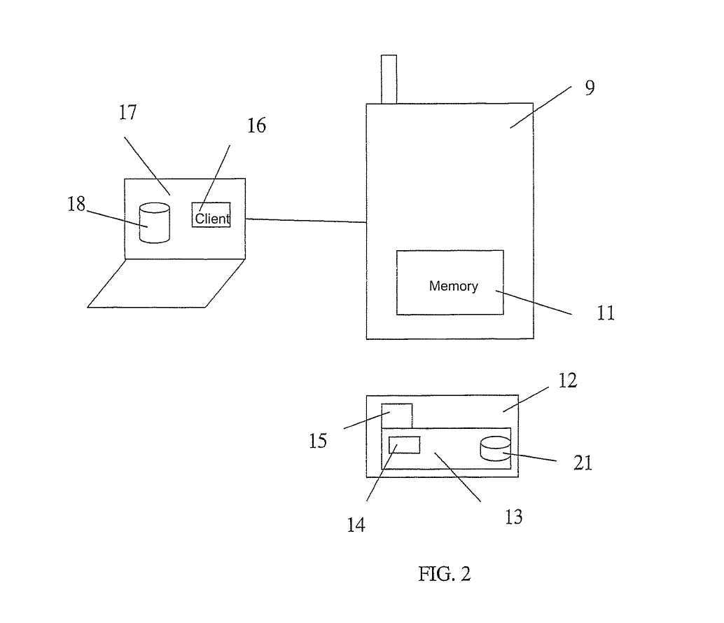

FIG. 2 shows an assembly comprising an a mobile equipment unit and a smart card according to a second embodiment of the invention;

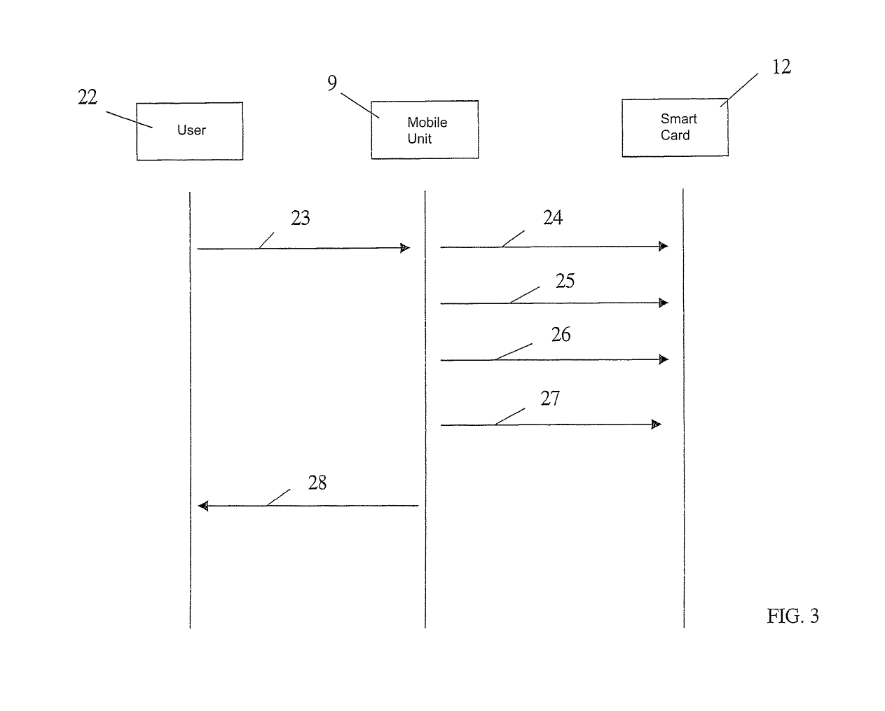

FIG. 3 shows a diagram of a first embodiment of a method according to the invention;

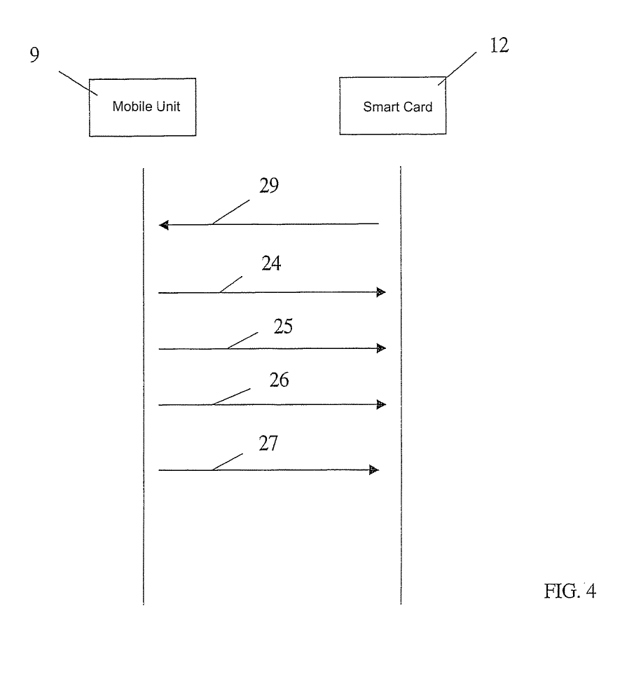

FIG. 4 shows a diagram of a second embodiment of a method according to the invention;

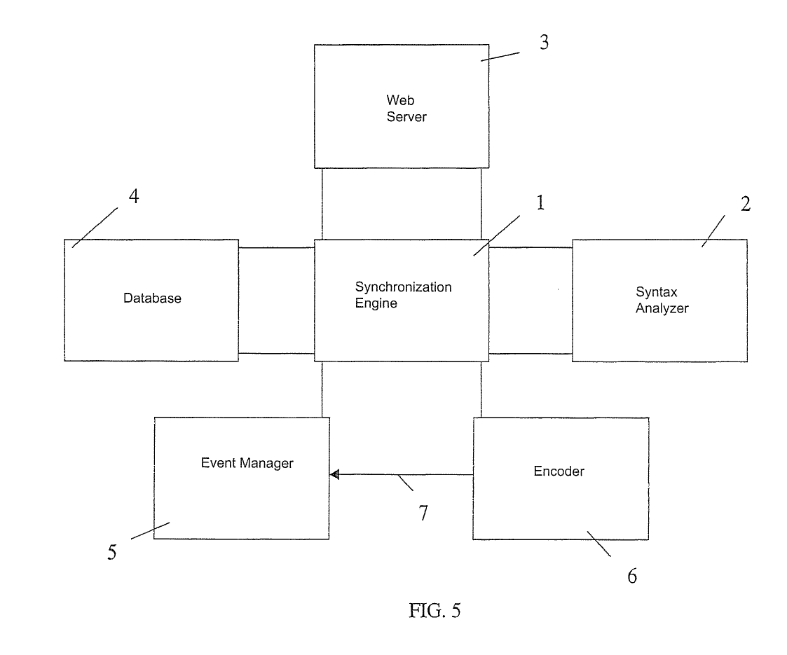

FIG. 5 shows a block diagram of a SyncML server stored in a smart card.

In FIG. 1 is illustrated an assembly 8 according to the invention which includes a mobile equipment unit 9. Such mobile equipment 9 includes memories 11. Such memories 11 comprise a SyncML client 11 in the form of a computer program which can be run using a processor. Memories 11 also include an equipment personal database 19. The mobile equipment unit 9 also includes an operation system and capacities of exchanging data with a smart card in the form a TCP/IP or BIP TCP or SC-TP interface.

The mobile equipment unit may be for example a mobile telephone or a personal assistant of the PDA type.

The assembly 8 also includes a smart card 12. Such a smart card includes a microprocessor 15 connected to memories 13. Such memories 13 include a SyncML server 14 and a personal database of the card 21. The SyncML server 14 is capable of allowing the synchronization of the card personal data with the equipment unit personal data through an exchange with the SyncML client 11 of the mobile equipment unit 9 when the smart card 12 is associated with the mobile equipment 9, for example through an electric contact when the smart card 12 is inserted into the mobile equipment 9. Such smart card 12 is for example a UICC card 12. The card 12 includes an operation system and data exchange, for example http or TCP, interfaces. The card 12 includes an http server allowing such exchanges.

When the connection is obtained between the card 12 and the mobile equipment unit, data can be exchanged between the card 12 and the mobile equipment unit 9.

Such exchange can be submitted to an authentication using the card security parameters and more particularly a PIN code. The synchronizations can thus be denied if the authentications with the PIN code of the card holder 12 failed.

In a first embodiment of the synchronization method according to the invention as illustrated in FIGS. 3 and 1, the mobile equipment unit 9 is held by a user 22. The user 22 configures the SyncML client 16 on a URL corresponding to the SyncML server 14 of the smart card 12. Such URL is defined by a local address and a port. The user then triggers 23 the synchronization of data between the mobile equipment unit 9 and the smart card 12. Thus, through an exchange of data according to the SyncML protocol, the personal data stored in a memory of the mobile unit 9 are saved in the smart card 12. Such synchronization includes an initialization phase 24, an authentication phase 25 of the card 12, a synchronization phase 26 according to the SyncML protocol and a synchronization end phase 27. Then the user is notified 28 that the synchronization is a success.

If the user 22 changes his or her mobile equipment unit and uses a new mobile equipment unit 9a also including memories 11a comprises a SyncML client 16a and the same capacities of data exchange as the mobile equipment 9, he or she can retrieve the data stored in the smart card 12 by inserting 10 such card 12 into the new mobile equipment 9a and by triggering a new synchronization according to the SyncML protocol. Thus, the personal data of the card 12 can be saved in a memory 11a of the new equipment unit 9a at the level of the database 19a.

If the equipment 9 is damaged, such personal data can thus be retrieved at the level of the new equipment 9a.

According to a second embodiment of the synchronization method according to the invention, as illustrated in FIG. 4, the synchronization described hereabove between the SyncML server 14 and the SyncML client 11 is automatically carried out at regular intervals without requiring a user's operation. In this case, the SyncML server 14 of the card 12 transmits 29 a request to the SyncML client 16 of the mobile equipment unit 9 so that the SyncML client 16 carries out a synchronization operation. This is performed by a server warning function, also known as SERVER-ALERT. In this SERVER-ALERT mode, the SyncML server 14 of the card 12 sends 29 alerts to the SyncML client 16 of the mobile equipment unit 9 so that he/she triggers the synchronization of data for example everyday. The synchronization is then performed as in the embodiment described hereabove through an initialization 24, an authentication 25, a data synchronization 26 and a synchronization completion 27.

According to a third embodiment of the invention as illustrated in FIG. 2, the synchronization such as previously described is carried out from a SyncML client 16 located on a personal computer 17 locally connected to the mobile equipment unit 9, for example through a Wi-Fi protocol. The personal computer also includes a personal data base 18. Synchronization between the data in the card 12 and the data in the personal computer 17 can thus be carried out when the card 12 is associated with the mobile equipment unit 9. The exchange of data is for example first carried out from the personal equipment 17 towards the mobile equipment unit 9 through the Wi-Fi protocol, then from the mobile equipment unit 9 to the card 12 through a TCP protocol. The reverse exchange is also possible to update the data in the database 18 with the data in the card 12. The SyncML client 16 of the personal computer 17 is for example a SyncML client of a known contact manager of the Outlook type.

Now the SyncML server 16 of the smart card 12 will be described in greater detail while referring to FIG. 5.

The SyncML server 16 is a computer program which can be run using the processor 15. The program languages used are for example Javacard, with parts encoded in C language mainly for performances and flexibility reasons.

The SyncML server 16 includes a synchronization engine 1 which can communicate with a Web server 3 with a syntax analyzer of the WBXML format 2, with an encoder in the WBXML format 6, with a database 4 and with an event manager 5. The synchronization engine 1 is for example written in Java language.

Now the syntax analyzer of the WBXML format 2 will be described in greater details. This module 2 is preferably written in C language and is called by the synchronization engine 1. The module 2 is capable of carrying out a syntax analysis of WBXML nodes.

The syntax analyzer 2 also includes an initialization code block capable of carrying out the following functions:
initialization of the syntax analysis;
specification of a file containing a WBXML packet to be analyzed;
specification of a table in which various values useful for the syntax analysis are stored.

The syntax analyzer 2 also includes a search code block capable of carrying out a function of searching for the value of the next WBXML node to be analyzed.

The syntax analyzer 2 also includes an analysis code block which analyses the tree of the next WBXML node determined by the search code block and which stores in the memory the useful information resulting from the analysis.

The syntax analyzer 2 also includes a retrieval code block which retrieves the data analyzed by the analysis code block.

In addition, the SyncML protocol defines a processing for large information in the section relating to multiple messages in a packet and to the processing of large objects which is called “Multiple Messages & Large Object Handling”. According to the invention, the volatile memory of the smart card 12 is not sufficient for carrying the conventional processing of such multiple messages. Then, a temporary storage in the non volatile memory is carried out in the card for the WBXML packets prior to their processing by a syntax analysis module 2. When a packet is processed, the preceding packet is then still stored in the temporary memory. This makes it possible to manage the WBXML nodes which are not ordered.

The synchronization engine 1 includes a SyncML synchronization engine as well as two Java applet classes capable of managing the SyncML flow coming into and going out from the synchronization engine 1.

The SyncML synchronization engine is a Java applet class comprising a syntax analysis method which generates the appropriate answers as a function of the SyncML protocol when nodes are analyzed.

The function of the WBXML encoder 4 is to encode the data received for example from the mobile equipment unit 9 in the WBXML format so as to allow the subsequent analysis such as previously described.

The Web server 3 function is to allow exchanges in the http format to and from the synchronization engine 1 and to and from the mobile equipment unit 9.

The database 6 includes card personal data capable of being synchronized with the mobile equipment unit personal data. When a personal datum of the database 6 is updated by a SyncML synchronization, a notification 7 is transmitted to the event manager 5 which stores the action carried out by the updating.

This action can be a modification of a personal datum, the addition of a personal datum or a deletion of a personal datum.

Further to the synchronization, when a personal datum must be updated in a new mobile equipment unit 9a comprising a new SyncML client 16a, the updating is carried thanks to the action stored in the event manager 5 of the smart card 12.

The storage in the non volatile memory of the actions on the various personal data thus enables to gain memory space which is adapted to the implementation of the SyncML server 14 in a smart card 12.

Similarly, the anchor such as defined in the SyncML protocol which is associated with each client is kept in the non volatile memory of the card upon each synchronization.

The GUID and LUID information on the personal data are also stored in the non volatile memory in the form of two matrices, one matrix including the GUID associated to an internal reference on the personal data and the other containing for each GUID the list of the client LUIDs.

1-10. (canceled)

11. A method for synchronizing personal data between a memory of at least one mobile equipment unit and an external device, each mobile equipment unit including or being connected to a SyncML synchronization client, the external device comprising a SyncML synchronization server associated with the SyncML synchronization client, wherein the external device is a smart card, and the method comprises the following steps:
associating the smart card with the mobile equipment unit;
transmitting a synchronization request from the SyncML synchronization client to the SyncML synchronization server; and
in the SyncML synchronization server, synchronizing the personal data between the smart card and the mobile equipment unit.

12. The method according to claim 11, wherein the SyncML synchronization server includes a WBXML application protocol.

13. The method according to claim 11, wherein the smart card comprises a non-volatile memory that stores a database including server personal data and an event manager including actions on the personal data, and wherein the step during which the SyncML synchronization server synchronizes the personal data between the smart card and the mobile equipment unit includes the following sub-steps, wherein:
one personal datum to be updated is updated by an action;
the action is recorded in the event manager; and
for any synchronization subsequent to the recording, the personal datum is updated by the action.

14. A method according to claim 13, wherein the smart card is connected to a first mobile equipment unit including a first SyncML synchronization client, and wherein:
the first SyncML synchronization client transmits a request for synchronization to the SyncML synchronization server;
the SyncML synchronization server synchronizes the personal data between the smart card and the first mobile equipment unit, including sub-steps in which:
one personal datum to be updated is updated by an action; and
the action is recorded in the event manager;
the smart card is connected to a second mobile equipment unit including a second SyncML synchronization client;
the second SyncML synchronization client transmits a request for synchronization to the SyncML synchronization server; and
the SyncML synchronization server transmits to the second SyncML synchronization client the action for updating the version of the personal datum to be updated in the second equipment.

15. A method according to claim 11, wherein each mobile equipment unit is associated with an anchor and the step in which the SyncML synchronization server synchronizes the personal data between the smart card and the mobile equipment unit includes a sub-step wherein:
the anchor is recorded in a non-volatile memory of the smart card.

16. A method according to claim 11, wherein:
the SyncML synchronization server stores, in a non-volatile memory of the smart card, a first matrix including a GUID identifier of each one of the personal data; and
the server stores into a non-volatile memory of the smart card, a first matrix including for each GUID identifier of each one of the personal data, a list of the LUID identifiers of each SyncML synchronization client.

17. A method according to claim 1, wherein the step during which the SyncML synchronization server synchronizes the personal data between the smart card and the mobile equipment includes sub-steps wherein the server:
receives a first packet of synchronization data;
stores the first packet in a first memory area of a non-volatile memory of the smart card;
receives a second packet of synchronization data; and
stores the second packet in a second memory area of the non-volatile memory of the smart card.

18. A method according to claim 11, wherein the smart card includes a non-volatile memory which stores a server database including server personal data and an event manager including actions on the personal data, and wherein the step during which the SyncML synchronization server synchronizes the personal data between the smart card and the mobile equipment unit includes the following sub-steps wherein:
the client sends the server an updated version relating to personal data stored in the server database;
the server transmits the updated version to the database;
the database updates the server personal data using the updated version;
the server searches the event manager for actions to be implemented at the mobile equipment unit; and
the server transmits the actions to the client.

19. A smart card including at least one memory block and a microprocessor, wherein the memory block stores a computer program, the program being configured to perform the functions of a SyncML server when it is executed by the microprocessor.

20. An assembly including a mobile equipment unit and a smart card, the mobile equipment unit including or being connected to a SyncML synchronization client, the smart card being associated with the mobile equipment unit and including at least one memory block and one microprocessor, wherein the memory stores a computer program, the program being configured to perform the functions of a SyncML server when it is executed by the microprocessor.

21. The method according to claim 12, wherein the smart card comprises a non-volatile memory that stores a database including server personal data and an event manager including actions on the personal data, and wherein the step during which the SyncML synchronization server synchronizes the personal data between the smart card and the mobile equipment unit includes the following sub-steps, wherein:
one personal datum to be updated is updated by an action;
the action is recorded in the event manager; and
for any synchronization subsequent to the recording, the personal datum is updated by the action.

22. A method according to claim 12, wherein each mobile equipment unit is associated with an anchor and the step in which the SyncML synchronization server synchronizes the personal data between the smart card and the mobile equipment unit includes a sub-step wherein:
the anchor is recorded in a non-volatile memory of the smart card.

23. A method according to claim 13, wherein each mobile equipment unit is associated with an anchor and the step in which the SyncML synchronization server synchronizes the personal data between the smart card and the mobile equipment unit includes a sub-step wherein:
the anchor is recorded in a non-volatile memory of the smart card.

24. A method according to claim 14, wherein each mobile equipment unit is associated with an anchor and the step in which the SyncML synchronization server synchronizes the personal data between the smart card and the mobile equipment unit includes a sub-step wherein:
the anchor is recorded in a non-volatile memory of the smart card.

25. A method according to claim 12, wherein:
the SyncML synchronization server stores, in a non-volatile memory of the smart card, a first matrix including a GUID identifier of each one of the personal data; and
the server stores into a non-volatile memory of the smart card, a first matrix including for each GUID identifier of each one of the personal data, a list of the LUID identifiers of each SyncML synchronization client.

26. A method according to claim 13, wherein:
the SyncML synchronization server stores, in a non-volatile memory of the smart card, a first matrix including a GUID identifier of each one of the personal data; and
the server stores into a non-volatile memory of the smart card, a first matrix including for each GUID identifier of each one of the personal data, a list of the LUID identifiers of each SyncML synchronization client.

27. A method according to claim 14, wherein:
the SyncML synchronization server stores, in a non-volatile memory of the smart card, a first matrix including a GUID identifier of each one of the personal data; and
the server stores into a non-volatile memory of the smart card, a first matrix including for each GUID identifier of each one of the personal data, a list of the LUID identifiers of each SyncML synchronization client.

28. A method according to claim 15, wherein:
the SyncML synchronization server stores, in a non-volatile memory of the smart card, a first matrix including a GUID identifier of each one of the personal data; and
the server stores into a non-volatile memory of the smart card, a first matrix including for each GUID identifier of each one of the personal data, a list of the LUID identifiers of each SyncML synchronization client.

29. A method according to claim 13, wherein the step during which the SyncML synchronization server synchronizes the personal data between the smart card and the mobile equipment includes sub-steps wherein the server:
receives a first packet of synchronization data;
stores the first packet in a first memory area of a non-volatile memory of the smart card;
receives a second packet of synchronization data; and
stores the second packet in a second memory area of the non-volatile memory of the smart card.

30. A method according to claim 16, wherein the step during which the SyncML synchronization server synchronizes the personal data between the smart card and the mobile equipment includes sub-steps wherein the server:
receives a first packet of synchronization data;
stores the first packet in a first memory area of a non-volatile memory of the smart card;
receives a second packet of synchronization data; and
stores the second packet in a second memory area of the non-volatile memory of the smart card.
